(19) United States
(12) Patent Application Publication
(10) Pub. No.: US 2023/0310997 A1
(43) Pub. Date: Oct. 5, 2023

(54) INFORMATION PROCESSING DEVICE, INFORMATION PROCESSING METHOD AND PROGRAM

(71) Applicant: NEC Corporation, Tokyo (JP)

(72) Inventors: Kiri INAYOSHI, Tokyo (JP); Takashi Nonaka, Tokyo (JP); Kentaro Nishida, Tokyo (JP)

(73) Assignee: NEC Corporation, Tokyo (JP)

(21) Appl. No.: 18/101,972

(22) Filed: Jan. 26, 2023

(30) Foreign Application Priority Data
Mar. 30, 2022 (JP) 2022-056538

(51) Int. Cl. A63F 13/56; A63F 13/79; G06N 3/0475

(52) U.S. Cl. CPC A63F 13/56; A63F 13/79; G06N 3/0475; A63F 2300/8082

(57) ABSTRACT

An information processing device (1) executes: an acquisition process of acquiring an action history of one or more players in a virtual space; and an action information generating process of generating, from the action history of the one or more players, action information indicating an action which a non-player character is to perform.

### CROSS REFERENCE TO RELATED APPLICATIONS

This application is based upon and claims the benefit of priority from Japanese Patent Application No. 2022-056538 filed on Mar. 30, 2022, the disclosure of which is incorporated herein in its entirety by reference.

### TECHNICAL FIELD

The present invention relates to an information processing device, an information processing method and a program.

### BACKGROUND ART

Many characters appear in a virtual reality space such as a metaverse, in a computer game, or the like. In a computer game, in addition to a player character (hereinafter, also referred to as “PC”) which is operated by a user, a non-player character (hereinafter, also referred to as “NPC”) which is controlled by a game program appears. In a metaverse, in addition to an avatar which is operated by a user, another avatar which is operated by another user exists, and further, an avatarbot equivalent to an NPC which is controlled by a program may appear.

For example, Patent Literature 1 discloses a game program and a game system that can make, in a game in which a PC and an NPC appear in a virtual reality space, an event which changes an action of the NPC closer to an event in the real world.

Further, Patent Literature 2 discloses a technique for generating an NPC that acts in a game space and controlling an action of the NPC in accordance with a game situation.

### CITATION LIST

### Patent Literature

[Patent Literature 1]

Japanese Patent Application Publication Tokukai No. 2021-166851

[Patent Literature 2]

Japanese Patent Application Publication Tokukai No. 2017-51633

### SUMMARY OF INVENTION

### Technical Problem

However, the NPC disclosed in Patent Literature 1 is a character that has been created in advance, and a scene in which the NPC appears has also been assumed in advance. Further, an NPC disclosed in Patent Literature 2 assumes using an NPC that has been used in another account. These NPCs are existing NPCs, and scenes in which the NPCs are to appear have also been assumed in advance. Therefore, these NPCs do not always match an environment of an arbitrary virtual reality space in which a user participates.

An example aspect of the invention is attained in view of the above problem. An example object of the invention is to provide a technique for generating an action which is to be performed by an NPC that is disposed in a virtual reality space where a user participates and about which the user is unlikely to feel odd.

### Solution to Problem

An information processing device according to an example aspect of the invention includes at least one processor, the processor executing: an acquisition process of acquiring an action history of one or more players in a virtual space; and an action information generating process of generating, from the action history of the one or more players, action information indicating an action which a non-player character is to perform.

An information processing method according to an example aspect of the invention is a method in which at least one processor acquires an action history of one or more players in a virtual space, and generates, from the action history of the one or more players, action information that indicates an action which a non-player character is to perform.

A storage medium according to an example aspect of the invention is a computer-readable non-transitory tangible storage medium storing therein a program for causing a computer to execute: an acquisition process of acquiring an action history of one or more players in a virtual space; and a generation process of generating, from the action history of the one or more players, action information that indicates an action which a non-player character is to perform.

### Advantageous Effects of Invention

An example aspect of the invention makes it possible to generate an action which is to be performed by an NPC that is disposed in a virtual reality space where a user participates and about which the user is unlikely to feel odd.

### BRIEF DESCRIPTION OF DRAWINGS

FIG. 1 is a block diagram illustrating a configuration of an information processing device 1 in accordance with a first example embodiment of the invention.

FIG. 2 is a flowchart illustrating a flow of an information processing method S1 in accordance with the first example embodiment.

FIG. 3 is a block diagram illustrating a configuration of an information processing device 2 in accordance with a second example embodiment of the invention.

FIG. 4 is a table showing an example of divided action categories in accordance with the second example embodiment.

FIG. 5 is a schematic diagram illustrating an example of a method of determining the number of NPCs in accordance with a density of players in a virtual space.

FIG. 6 is an example of an image that is displayed on a display section of an information processing device 3.

FIG. 7 is a block diagram illustrating a configuration of an information processing device 3A in accordance with a third example embodiment of the invention.

FIG. 8 is a configuration diagram for realizing an information processing device by software.

### EXAMPLE EMBODIMENTS

### First Example Embodiment

The following description will discuss in detail a first example embodiment of the invention, with reference to drawings. The present example embodiment is an embodiment that serves as a base for example embodiments which will be described later. It is possible to use an information processing device 1 in accordance with the present example embodiment, for example, as a part of a server which stores a virtual reality space (hereinafter, also referred to as “virtual space”) that has been constructed on a computer and which provides a user with the virtual space. It is alternatively possible to use the information processing device 1 as a part of a terminal device which a user, that is, a player who participates in the virtual space uses. As a terminal device that a player uses, a personal computer, a head-mounted display, an eyeglass-type display, or the like can be used.

A virtual space like a metaverse is not a space in which a predetermined game is to be played. In a system of the virtual space, a voluntary player participates at any time. Moreover, there are various types of environments of the virtual space. Therefore, depending on a situation, there may be a time period in which few players participate in the virtual space and the virtual space is inactive. In such a case, it is preferable to cause an NPC to appear in the virtual space so as to make the virtual space look active. The information processing device 1 generates an NPC that matches the virtual space, when there are few participants.

(Configuration of Information Processing Device 1)

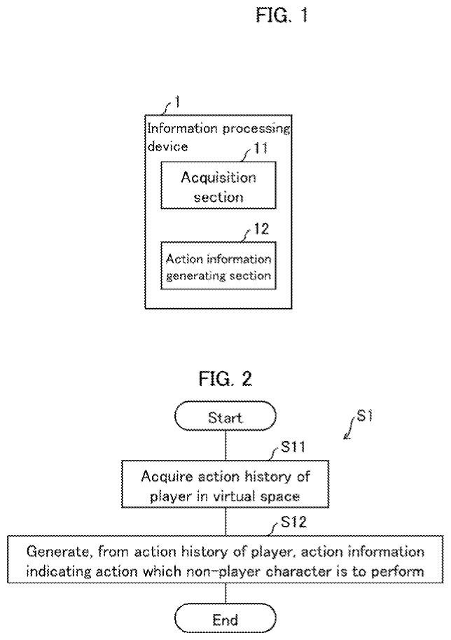

The following will discuss a configuration of an information processing device 1 in accordance with the present example embodiment, with reference to FIG. 1. FIG. 1 is a block diagram illustrating the configuration of the information processing device 1. As illustrated in FIG. 1, the information processing device illustrated in FIG. 1 includes an acquisition section 11 and an action information generating section 12. The acquisition section 11 and the action information generating section 12 are example embodiments of an acquisition means and an action information generating means, respectively.

The acquisition section 11 acquires an action history of one or more players in a virtual space in which a plurality of players participate. The action history refers to an action that a certain player has actually performed. In one example, the action history may be a walking action, a running action, a dancing action, an action of calling another player, an action of having a conversation, or the like action that a player who has existed in the past has made in the virtual space. The acquisition section 11 acquires, as appropriate, the action history of the one or more players while the one or more players participate and act in the virtual space. The acquisition section 11 may acquire an action of each of the players for each of different scenes or each of different environments.

The action information generating section 12 generates, from the action history of the one or more players which has been acquired by the acquisition section 11, action information that indicates an action which a non-player character (hereinafter, referred to as “NPC”) is to perform. The NPC is not an actually participating player, but is a character that is disposed in the virtual space and that imitates an unspecified person. The action information is preferably a set of coherent actions, but may be a fragmentary action. The length of one action information (action time) is also not particularly limited. Note that the action information generated by the action information generating section 12 expresses an action which the NPC is to perform. In this case, the NPC that exhibits the action is not limited to any specific NPC type. For example, the NPC may be an NPC that is shared in various virtual spaces, or an NPC that the information processing device 1 has newly generated.

The action information generating section 12 may generate one or more pieces of action information from the action history of a single player. Alternatively, the action information generating section 12 may combine respective action histories of two or more players and generate one or more pieces of action information. When generating the action information from the action history of a single player, it is preferable that the action information generating section 12 generate one piece of action information by combining a plurality of action histories of one category, rather than generate one piece of action information from one action history. The category is a division of an action. Examples of the category include walking, running, dancing, calling, having a conversation, etc. Generation of one piece of action information by combining a plurality of action histories of one category makes it possible to reduce the possibility that a generated piece of action information becomes an imitation of an action of a certain player. It should be noted that the “category” in accordance with the present example embodiment may include not only a category that is set in advance by a user, but also a division that is made of, for example, a cluster which is generated by clustering through a trained classification model. Further, the “category” in accordance with the present example embodiment is not limited to a category to which a category name is explicitly assigned, but may be a category to which no category name is explicitly assigned.

The action information generating section 12 may generate action information with use of the action history which has been acquired by the acquisition section 11 for each of the different scenes or each of the different environments. The action information generated with use of the action history which has been acquired in a certain scene or a certain environment can be action information that is suited in a scene similar to that certain scene or an environment similar to that certain environment. The NPC that acts on the basis of such action information makes a move that is less odd in the eyes of a participating user.

With regard to sections of the information processing device 1, as least some of the sections may be arranged in a distributed manner. In addition, some or all of the sections of the information processing device 1 may be located in the cloud. This also applies to example embodiments that will be described below.

(Effects of Information Processing Device 1)

As described above, the information processing device 1 in accordance with the present example embodiment employs a configuration that includes: an acquisition section 11 that acquires an action history of one or more players in a virtual space; and an action information generating section 12 that generates, from the action history of the one or more players, action information that indicates an action which a non-player character is to perform. Therefore, the information processing device 1 in accordance with the present example embodiment can provide the effect of making it possible to provide a technique for generating an action which is to be performed by an NPC that is disposed in a virtual reality space where a user participates and about which the user is unlikely to feel odd. Further, according to the information processing device 1 in accordance with the present example embodiment, the action generated is an action based on action information that is generated with reference to an action history of a player that has existed in the virtual space in the past. Since the NPC that performs such an action is disposed in the virtual space, it is possible to provide the effect of eliminating, without causing odd feeling, loneliness that may be felt when there are few players in the virtual space.

(Flow of Information Processing Method S1)

The following will discuss a flow of an information processing method S1 in accordance with the present example embodiment, with reference to FIG. 2. FIG. 2 is a flowchart illustrating a flow of the information processing method S1.

As illustrated in FIG. 2, the information processing method S1 includes steps S11 and S12. In step S11, at least one processor (for example, the acquisition section 11) acquires an action history of one or more players in a virtual space. The meaning of the action history is as described above.

Next, in step S12, at least one processor (for example, the action information generating section 12) generates, from the action history of the one or more players, action information that indicates an action which a non-player character is to perform. The meaning of the non-player character (NPC) is as described above.

(Effects of Information Processing Method S1)

As described above, the information processing method S1 in accordance with the present example embodiment employs a configuration in which at least one processor acquires an action history of one or more players in a virtual space, and generates, from the action history of the one or more players, action information that indicates an action which a non-player character is to perform. Therefore, the information processing method S1 in accordance with the present example embodiment can provide the effect of making it possible to provide a technique for generating an action which is to be performed by an NPC that is disposed in a virtual reality space where a user participates and about which the user is unlikely to feel odd. Further, according to the information processing method S1 in accordance with the present example embodiment, the action generated is an action based on action information that is generated with reference to an action history of a player that has existed in the virtual space in the past. Since the NPC that performs such an action is disposed in the virtual space, it is possible to provide the effect of eliminating, without causing odd feeling, loneliness that may be felt when there are few players in the virtual space.

### Second Example Embodiment

The following description will discuss in detail a second example embodiment of the invention, with reference to drawings. Note that components having the same functions as those described in the first example embodiment are denoted by the same reference numerals, and a description thereof will be omitted accordingly.

(Configuration of Information Processing Device 2)

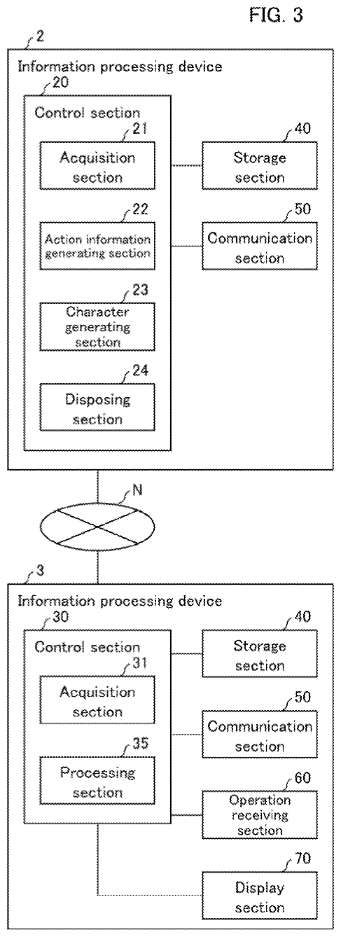

FIG. 3 is a block diagram illustrating a configuration of an information processing device 2 in accordance with the second example embodiment. Note that FIG. 3 also illustrates a configuration of an information processing device (terminal device) 3 that is connected to the information processing device 2.

The information processing device 2 is a server which stores a virtual space that has been constructed, and which performs information communication with an information processing device 3 that a user who participates in the virtual space uses. As illustrated in FIG. 3, the information processing device 2 includes a control section 20, a storage section 40, and a communication section 50. With regard to sections of the information processing device 2, at least some of the sections may be arranged in a distributed manner. In addition, some or all of the sections of the information processing device 2 may be located in the cloud.

Examples of the storage section 40 may include various RAMs (random access memories) and ROMs (read only memories). Various programs are stored in a ROM. Then, the function of each section of the control section 20 is realized by at least one processor loading the various programs stored in the ROM into a RAM and executing the various programs. Further, in the RAM, an action history, action information, character information and the like, which will be described later, are recorded. The communication section 50 performs information communication with the information processing device 3.

The control section 20 performs overall control of the whole of the information processing device 2, and includes an acquisition section 21, an action information generating section 22, a character generating section 23, and a disposing section 24. The acquisition section 21, the action information generating section 22, the character generating section 23, and the disposing section 24 are example embodiments of an acquisition means, an action information generating means, a character generating means, and a disposing means, respectively.

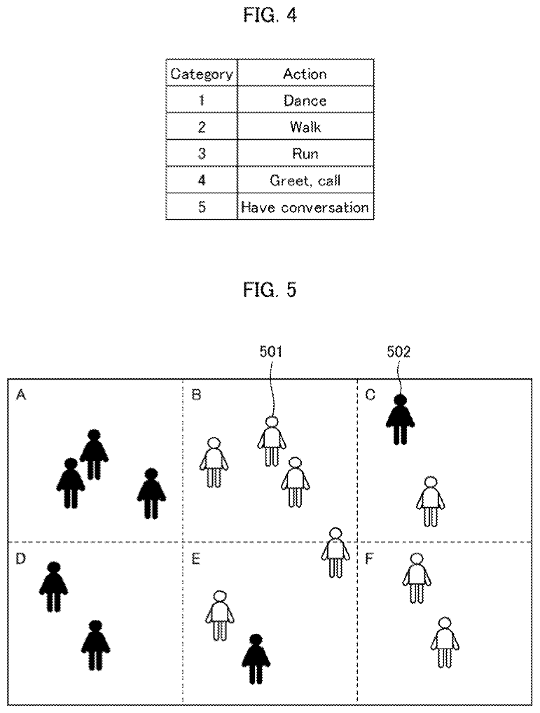

The acquisition section 21 acquires an action history of one or more players in a virtual space in which a plurality of players participate, and records the action history in the storage section 40. The action history is as described in the first example embodiment. The action history of the one or more players may be classified into a plurality of categories and managed. The categories are as described in the first example embodiment. FIG. 4 is a table showing examples of divided action categories. In an example illustrated in FIG. 4, Category 1 corresponds to an action of dancing or stopping dancing, Category 2 corresponds to an action of walking or stopping walking, Category 3 corresponds to an action of running or stopping running, Category 4 corresponds to an action at the time of greeting or calling, and Category 5 corresponds to an action at the time of having a conversation. The action at the time of greeting or calling is, for example, an action of raising a hand, waving a hand, smiling, etc. The action at the time of having a conversation is, for example, an action of spreading both hands, nodding, or looking at a direction in which a conversation partner points. The acquisition section 21 sorts an action(s) of the one or more players into such a category (categories), and acquires and stores the action(s).

The acquisition section 21 classifies the action history into the plurality of categories and manages the action history. This makes it possible to generate, with reference to such a category, the action information which indicates an appropriate action that is suited to an environment or a situation, when the action information generating section 22, which will be described later, generates the action information.

The acquisition section 21 may acquire a licensed action history or an action history that does not require licensing. The licensed action history refers to an action history that corresponds to a certain action which a user has made and for use of which the user has gave a permission or consent to another user. Use of an action means that another person makes the action or an action similar to the action. The action history that does not require licensing refers to an action which is not recognized as an action of a particular person.

A new action that is different from a normal action is recognized in association with a particular person who first made the new action. If an action which many users recognize as an action that has been made by a particular person is imitated, such imitation may be blamed by the particular person or another user. It is thus preferable that the acquisition section 21 acquire a licensed action history or an action history that does not require licensing.

The action information generating section 22 generates, from the action history of the one or more players which has been acquired by the acquisition section 21, action information that indicates an action which an NPC is to perform, and records the action information in the storage section 40. The NPC is as described in the first example embodiment. The action information generating section 22 may generate the action information from an action history that is included in a category which has been selected from a plurality of categories. As described above, the action information generating section 22 can generate, with reference to this category, action information which indicates an appropriate action that is suited to an environment or a situation.

The action information generating section 22 may select the category in accordance with the action and/or a position of the one or more players in the virtual space. In one example, when a certain player is walking, the action information generating section 22 may select the category of “greeting/calling” that is an action to be made with respect to the player. In addition, when there is a place in which only a small number of players exist, an active category, such as the category of “running” or the category of “dancing”, may be selected as an action of the NPC that is disposed in the place. Selecting an active action can give the players a more lively impression, as compared to a case in which simply standing or walking is selected.

The action information generating section 22 may also acquire context information and select a category in accordance with the context information thus acquired. The context information is information which is referred to when an NPC is disposed. In one example, the context information may indicate an NPC performing what action is not sufficient where in the whole or a part of the virtual space.

In this case, the information processing device 2 may include a context information generating section (not illustrated), which generates the context information in accordance with a position(s) and/or the action(s) of a player(s) in the whole or a part of the virtual space.

In one example, the context information generating section acquires information on how many players are present where in the virtual space. When the context information generating section acquires information which indicates that there is an area in which no player exists around an area in which a plurality of players exist, the context information generating section generates context information which indicates that an NPC performing an action similar to an existing player should be disposed in the area in which no player exists. The action information generating section 22 acquires such context information that has been generated by the context information generating section, and generates action information that indicates an action which is to be performed by the NPC that is to be disposed in the area in which no player exists.

The action information generating section 22 may generate one piece of action information by dividing, for example, in units of several seconds, action histories acquired by the acquisition section 21 and appropriately combining actions into which action histories of one category have been divided. It is preferable that the action information generating section 22 generate a large number of pieces of such action information. This makes it possible to prevent the action information generated for the NPC from becoming action information indicating an action similar to an action of a particular player that has existed in the past, by frequently changing the action of the NPC with use of the plurality of pieces of action information. This will be described later.

The information processing device 2 may also include a similarity determination section which executes determination as to how much the action information that has been generated by the action information generating section 22 is similar to an action history which is of a player that has existed in the past and which the acquisition section 21 has acquired. Then, the action information generating section 22 may be configured to leave only action information whose highest degree of similarity is not more than a predetermined value and to discard the other action information. This makes it possible that, even if action information similar to an action history of a player that has existed in the past should be generated, use of such action information can be prevented. The determination section may use, for example, a trained determination model.

In one example, the action information generating section 22 may generate the action information with use of a generative model. The generative model in the present example embodiment is a model that has been trained so as to generate action information with use of an action history as an input.

The generative model may be, for example, a model that utilizes a convolutional neural network (CNN), a recursive neural network (RNN), an autoencoder that includes an encoder and a decoder, a generative adversarial network (GAN) that uses an action history as seed information, or a combination thereof.

The generative model may be a model that has been trained via supervised learning or may be a model trained via unsupervised learning. In the supervised learning, it is possible to use an action history and label data that is attached to the action history. The label data may indicate action information that is to be generated from the action history.

In one example, the generative model may be a classification model that has been trained via unsupervised learning for clustering. For example, such a generative model may generate skipping action information by combining, for example, a walking action and a running action that are classified from an action history of a player. In this way, the generative model may generate new action information by combining action histories that are included in one cluster or in different clusters among action histories that have been subjected to clustering.

The character generating section 23 of the control section 20 generates character information of the NPC that performs the action which is indicated by the action information. The character information refers to data that includes the shape and texture of each portion of the NPC. Each portion is, for example, a head, hands, feet, or torso, and is also referred to as a part. The texture in the present example embodiment is an appearance such as the material quality and color of a part of the NPC. In addition, the character information may be information in which data that includes the shape and texture of parts of the NPC is associated with the action information.

In one example, the character generating section 23 may generate character information of one NPC by randomly combining parts of avatars of players that have existed in the virtual space in the past. Further, it is preferable that the character generating section 23 generate the character information of many NPCs in such a way. Then, the disposing section 24, which will be described later, may frequently change the character of the NPC to be disposed. Further, it is possible to frequently change the action information that has been generated by the action information generating section 22 and apply the action information to the character, and cause the NPC to perform an action. Such processing allows the character or action of the NPC to be a new character or action that is not similar to a character or action of a particular player that has existed in the past.

The information processing device 2 may include a similarity determination section that executes determination as to how much a character newly generated by the character generating section 23 is similar to an avatar that has existed in the past. Then, the character generating section 23 may be configured to leave only a character whose highest degree of similarity is not more than a predetermined value and to discard the other characters. This makes it possible that, even if a character similar to an avatar that has existed in the past should be generated, use of such a character can be prevented. The determination section may use, for example, a trained determination model.

The character generating section 23 may also generate a character of the NPC by copying only a license-free (freely usable) avatar, or combining parts of such avatars.

The character information may be more detailed information in the case of an NPC that is disposed at a position relatively close to a player than in the case of an NPC that is used as a distant view and that is disposed at a position relatively far from the player. When a player approaches the NPC used as a distant view, the NPC may accordingly retreat and vanish.

On the other hand, the character generating section 23 may generate more detailed shape and texture information for an NPC that is relatively close to a player. It is also possible to cause NPCs to have a conversation with each other, for example, through synthesized voice or through only text display. In one example, the acquisition section 21 acquires a conversation between players that have existed in the virtual space in the past, and causes a chatbot to learn the conversation in advance. When only a small number of players exist, the chatbot that has been trained may be used to allow NPCs to have a conversation with each other as appropriate.

The character generating section 23 may generate the character information of the NPC with use of a licensed character material or a character material that does not require licensing. The character material that does not require licensing refers to a published character material that is open for use by anyone. In some cases, a character that is used in a metaverse or the like is created by a creator. In addition, in some cases, a part and/or a small tool of a character may be created by a creator. If a character similar to such a character is generated and used by the character generating section 23, infringement of a copyright may occur. On this account, it is preferable to generate character information of a non-player character by using a licensed character material or a character material that does not require licensing.

The disposing section 24 disposes, in the virtual space, an NPC based on the character information that has been generated by the character generating section 23. To “dispose” includes determining the position of the NPC in the virtual space. Further, the disposing section 24 may cause the disposed NPC to act according to the action information that is associated with the character information.

The disposing section 24 may determine the position at which the NPC is to be disposed, in accordance with the position of the one or more players in the virtual space. Disposing the NPC in a place that is not lively with players can make a player feel easy because many participants appear to exist in the virtual space. The disposing section 24 may determine a place in which only a small number of players exist or an area in which the density of players is small. The disposing section 24 then may dispose, in accordance with the number or density of players, the NPC in the place in which only a small number of players exist or in an area in which the density of players is small.

If the disposing section 24 determines, in accordance with the positions of the players in the virtual space, the position at which the NPC is to be disposed, the above-described action information generating section 22 may select, in accordance with positions of the players in the virtual space, a category of the action history for generating the action information of the NPC. In one example, if there is a place in which only a small number of players exist, it is possible to select an active category, such as the category of “running” or the category of “dancing”, as an action of the NPC that is to be disposed in that place. Such processing can give the players a more lively impression, as compared to a case in which the NPC is simply standing or walking.

In one example, the disposing section 24 may dispose, in the virtual space, more non-player characters in an area in which the density of the players is smaller than in an area in which the density of the players is larger. This makes it possible to give the players an impression that anywhere all over the virtual space is lively.

FIG. 5 is a schematic diagram illustrating an example of a method of determining the number of NPCs in accordance with the density of players in the virtual space. As illustrated in FIG. 5, consider a virtual space which is divided into six areas A to F. Players 501 that exist in the areas at a time point are shown in white figures. NPCs 502 that are to be newly disposed are shown in black figures. It should be noted that the players 501 and the NPCs 502 illustrated are not intended to show characters but intended to simply show positions.

FIG. 5 shows a result of disposition of the NPCs 502 by the disposing section 24 according to the following rules. That is, when two or more players 501 exist in one area, the disposing section 24 does not dispose any NPCs 502 in the area, as illustrated in the areas B and F. Moreover, the disposing section 24 randomly disposes two or three NPCs 502 in areas in which the number of players 501 is less than one, as illustrated in the areas A and D. In addition, the disposing section 24 randomly disposes one NPC 502 in areas in which the number of players 501 is not more than one but less than two, as illustrated in the areas C and D.

In the above example, although the disposing section 24 randomly selects the positions of the NPCs 502 in each of the areas, the positions of the NPCs 502 may be determined in consideration of the positional relationship with the players 501. For example, the disposing section 24 may dispose the NPCs 502 at respective positions each of which is a predetermined distance apart from the positions of all of the players 501. Application of such an NPC disposition method allows all of the players to have another user or an NPC present within a predetermined distance without fail.

Note that the disposing section 24 determines the positions of the NPCs 502 by a method that is not limited to the above-described method but that can be any other method. Further, as described above, the disposing section 24 may cause each of the NPCs 502 to act according to the action information.

Next, the following will discuss the information processing device 3 that is used by a user. The information processing device 3 is a terminal device that is used by a user (player). The information processing device 3 acquires information on the virtual space from the information processing device 2 and displays the information, and also transmits, to the information processing device 2, information on an operation made by the user. As illustrated in FIG. 3, the information processing device 3 includes a control section 30, a storage section 40, a communication section 50, an operation receiving section 60, and a display section 70.

The control section 30 performs overall control of the information processing device 3. In on example, the control section 30 includes an acquisition section 31 and a processing section 35. The acquisition section 31 acquires information from the information processing device 2. The processing section 35 receives, as an operation signal, the information on the operation that has been made by the player and that has been received by the operation receiving section 60, processes the operation signal, and transmits the operation signal to the information processing device 2 through the communication section 50. Further, the processing section 35 processes the information that the acquisition section 31 has acquired from the information processing device 2, and generates an image of the virtual space and displays the image on the display section 70.

The storage section 40 may include, for example, various RAMs and ROMs. Various programs are stored in a ROM. Then, the function of each section of the control section 30 is realized by at least one processor loading the various programs stored in the ROM into a RAM and executing the various programs. The communication section 50 performs information communication with the information processing device 2. The operation receiving section 60 receives an operation that is made by the player. The display section 70 displays an image that has been generated by the processing section 35.

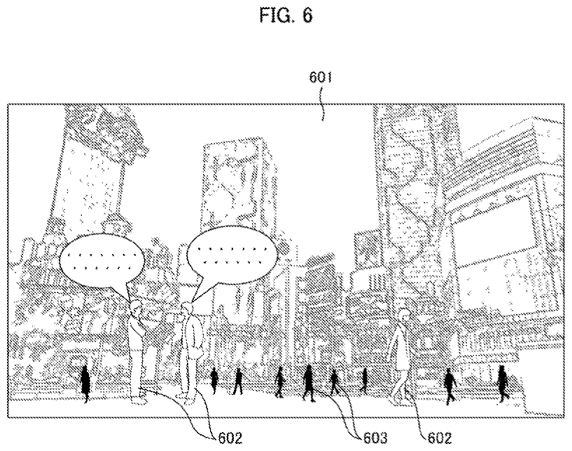

FIG. 6 is an example of an image that is displayed on the display section 70. As illustrated in FIG. 6, it is assumed that there is no player other than a user in a virtual space 601. In such a case, the information processing device 2 can generate and dispose (display) a plurality of NPCs. Distant NPCs 603 are displayed as small and simplified characters. The actions of the NPCs 603 are either walking or standing still. NPCs 602 on a near side may be displayed as detailed characters, and be having a conversation with each other.

(Effects of Information Processing Device 2)

As described above, the information processing device 2 in accordance with the present example embodiment is configured to include the acquisition section 21, the action information generating section 22, the character generating section 23, and the disposing section 24. Therefore, the information processing device 2 in accordance with the present example embodiment can provide, in addition to the effects which are yielded by the information processing device 1 in accordance with the first example embodiment, an effect that new action information which is not similar to an action of a particular player can be generated from an action history that has been acquired. Furthermore, it is possible to provide an effect that the virtual space can be effectively made lively by generating a character that acts on the basis of the action information and disposing the character at a position in need of the character.

### Third Example Embodiment

The following description will discuss in detail a third example embodiment of the invention, with reference to drawings. Note that components having the same functions as those described in the first example embodiment or the second example embodiment are denoted by the same reference numerals, and a description thereof will not be repeated.

(Configuration of Information Processing Device 3A)

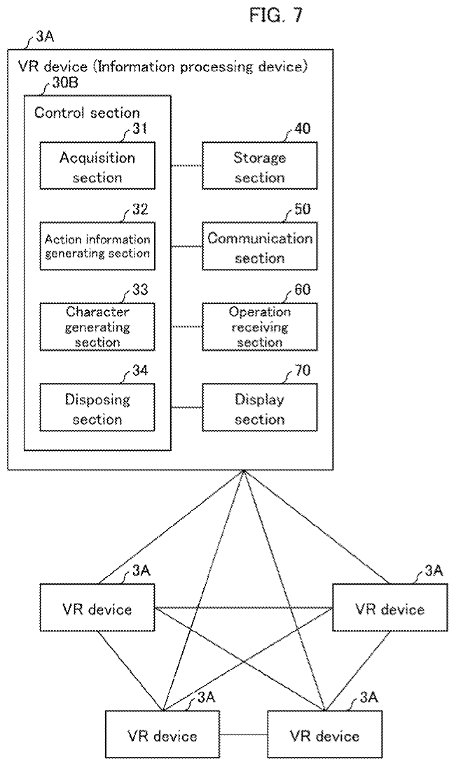

FIG. 7 is a block diagram illustrating a configuration of an information processing device 3A in accordance with the present example embodiment. The information processing device 3A is a terminal device that is used by a user. The information processing device 3A can be connected to a terminal device that is used by another user, so as to be capable of performing information communication with the terminal device in a peer-to-peer fashion without intervention of a server.

As illustrated in FIG. 7, the information processing device 3A includes a control section 30B, a storage section 40, a communication section 50, an operation receiving section 60, and a display section 70. In FIG. 7, although only one information processing device 3A is illustrated in detail, another information processing device 3A that is used by another user may have the same configuration. With regard to sections of the information processing device 3A, at least some of the sections may be arranged in a distributed manner or may be located in the cloud, except for the communication section 50, the operation receiving section 60, and the display section 70.

Examples of the storage section 40 may include various RAMs and ROMs. Various programs are stored in a ROM. Then, the function of each section of the control section 30B is realized by at least one processor loading the various programs stored in the ROM into a RAM and executing the various programs. In addition, in the RAM, the action history, the action information, the character, and/or the like that has/have been described in the second example embodiment may be recorded. The communication section 50 performs information communication with the information processing device 3A that is used by another user.

The control section 30B performs overall control of the whole of the information processing device 3A, and includes an acquisition section 31, an action information generating section 32, a character generating section 33 and a disposing section 34. The acquisition section 31, the action information generating section 32, the character generating section 33 and the disposing section 34 have the same functions as the acquisition section 21, the action information generating section 22, the character generating section 23 and the disposing section 24 of the information processing device 2 which has been described in the second example embodiment. The following will not provide any detailed description of these functions, but only provides a brief description of these functions.

For example, the acquisition section 31 acquires an action history of one or more players in a virtual space in which a plurality of players participate, and records the action history in the storage section 40. The action history of the one or more players may be classified into a plurality of categories and managed. The action history and categories of the action history are as described in the first or second example embodiment. Further, the acquisition section 31 may acquire a licensed action history or an action history that does not require licensing. It should be noted that the virtual space in accordance with the present example embodiment may be stored in the storage section 40 of the information processing device 3A which each user uses. The virtual space may be a virtual space that has been constructed jointly by users and stored in the cloud.

For example, the action information generating section 32 generates, from the action history of the one or more players which has been acquired by the acquisition section 31, action information that indicates an action which an NPC is to perform, and records the action information in the storage section 40. The NPC is as described in the first or second example embodiment. The action information generating section 32 may generate action information from an action history that is included in a category which has been selected from a plurality of categories. Further, the action information generating section 32 may select the category in accordance with the action and/or a position of the one or more players in the virtual space. Further, the information processing device 3A may include a context information generating section (not illustrated), which generates context information in accordance with a position(s) and/or the action(s) of a player(s) in the whole or a part of the virtual space. Furthermore, the action information generating section 32 may generate the action information with use of a generative model. The information processing device 3A may also include a similarity determination section which executes determination as to how much the action information that has been generated by the action information generating section 32 is similar to an action history which is of a player that has existed in the past and which the acquisition section 31 has acquired.

For example, the character generating section 33 generates character information of an NPC that performs the action which is indicated by the action information. The character information is as described in the second example embodiment. The character generating section 33 may generate the character information of the NPC with use of a licensed character material or a character material that does not require licensing. The information processing device 3A may include a similarity determination section that executes determination as to how much a character newly generated by the character generating section 33 is similar to an avatar that has existed in the past.

For example, the disposing section 34 disposes, in the virtual space, an NPC based on the character information that has been generated by the character generating section 33. The disposing section 34 may determine the position at which the NPC is to be disposed, in accordance with the position of the one or more players in the virtual space. In one example, the disposing section 34 may dispose, in the virtual space, more non-player characters in an area in which the density of the players is smaller than in an area in which the density of the players is larger. Note that the disposing section 34 determines positions of NPCs by a method that is not limited to the above-described method but that can be any other method.

(Effects of Information Processing Device 3A)

As described above, the information processing device 3A in accordance with the present example embodiment is configured to include the acquisition section 31, the action information generating section 32, the character generating section 33, and the disposing section 34. Therefore, the information processing device 3A in accordance with the present example embodiment can provide, in addition to the effects which are yielded by the information processing device 1 in accordance with the first example embodiment, an effect that new action information which is not similar to an action of a particular player can be generated from an action history that has been acquired. Furthermore, it is possible to provide an effect that the virtual space can be effectively made lively by generating a character that acts on the basis of the action information and disposing the character at a position in need of the character.

The information processing device 3A in accordance with the present example embodiment can be used as a terminal device that is owned by a user. Further, the information processing device 3A can be connected to another information processing device 3A of another user in a peer-to-peer fashion without intervention of a server. Therefore, the information processing device 3A in accordance with the present example embodiment makes it possible to provide, in addition to the effects that are yielded by the information processing device 1 in accordance with the first example embodiment, an effect that users can jointly construct a new virtual space without use of an existing virtual space and further an effect that the virtual space can be more effectively made lively.

### Software Implementation Example

Part or all of functions of the information processing device 1, 2, 3A (hereinafter, referred to as “information processing device 1 etc.”) can be realized by hardware such as an integrated circuit (IC chip) or the like or can be alternatively realized by software.

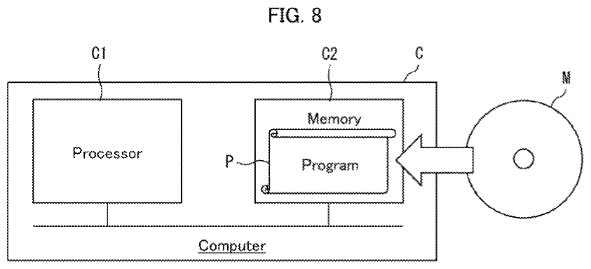

In the latter case, the information processing device 1 etc. is realized by, for example, a computer that executes instructions of a program that is software realizing the foregoing functions. FIG. 8 illustrates an example of such a computer (hereinafter, referred to as “computer C”). The computer C includes at least one processor C1 and at least one memory C2. In the memory C2, a program P for causing the computer C to operate as the information processing device 1 etc. is stored. In the computer C, the foregoing functions of the information processing device 1 etc. can be realized by the processor C1 reading and executing the program P stored in the memory C2.

Examples of the processor C1 encompass a central processing unit (CPU), a graphic processing unit (GPU), a digital signal processor (DSP), a micro processing unit (MPU), a floating point number processing unit (FPU), a physics processing unit (PPU), a microcontroller or a combination thereof. Examples of the memory C2 encompass a flush memory, a hard disk drive (HDD), a solid state drive (SSD) or a combination thereof.

Note that the computer C may further include a random access memory (RAM) in which the program P is loaded when executed and/or in which various data are temporarily stored. Moreover, the computer C may further include a communication interface for transmitting/receiving data to/from another device. In addition, the computer C may further include an input/output interface such as a keyboard, a mouse, a display, and/or a printer.

The program P can be stored in a non-transitory tangible storage medium M that can be read by the computer C. Examples of the storage medium M encompass a tape, a disk, a card, a semiconductor memory, and a programmable logic circuit. The computer C can obtain the program P via such a storage medium M. Further, the program P can be transmitted via a transmission medium. Examples of the transmission medium encompass a communication network or a broadcast wave. The computer C can obtain the program P via such a transmission medium.

[Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

[Additional Remark 2]

The whole or part of the example embodiments disclosed above can be described as, but not limited to, the following supplementary notes.

(Supplementary Note 1)

An information processing device including: an acquisition means that acquires an action history of one or more players in a virtual space; and an action information generating means that generates, from the action history of the one or more players, action information indicating an action which a non-player character is to perform.

The above configuration makes it possible to generate an action which is to be performed by an NPC that is disposed in a virtual reality space where a user participates and about which the user is unlikely to feel odd.

(Supplementary Note 2)

The information processing device according to Supplementary note 1, wherein: the action history of the one or more players is classified into a plurality of categories and managed; and the action information generating means generates the action information from the action history of a category that has been selected from the plurality of categories.

The above configuration makes it possible to efficiently generate action information.

(Supplementary Note 3)

The information processing device according to Supplementary note 2, wherein the action information generating means selects the category in accordance with the action and a position of the one or more players in the virtual space or in accordance with the action or a position of the one or more players in the virtual space.

The above configuration makes it possible to select, in accordance with an action(s) or a position(s) of a player(s), an action that is suited to the action(s) or the positions(s).

(Supplementary Note 4)

The information processing device according to any one of Supplementary notes 1 to 3, wherein the action information generating means generates the action information with use of a generative model.

The above configuration makes it possible to generate more natural action information by sufficiently training the generative model.

(Supplementary Note 5)

The information processing device according to any one of Supplementary notes 1 to 4, further including a character generating means that generates character information of the non-player character that is to perform the action indicated by the action information.

The above configuration makes it possible to generate character information of the NPC that performs the action on the basis of the action information that has been generated.

(Supplementary Note 6)

The information processing device according to Supplementary note 5, further comprising a disposing means that disposes, in the virtual space, the non-player character based on the character information that has been generated by the character generating means.

The above configuration makes it possible to dispose, in the virtual space, the NPC that has been generated on the basis of the character information.

(Supplementary Note 7)

The information processing device according to Supplementary note 6, wherein the disposing means determines a position at which the non-player character is to be disposed, in accordance with a position of the one or more players in the virtual space.

The above configuration makes it possible to dispose the NPC at an appropriate position in consideration of the position(s) of the player(s).

(Supplementary Note 8)

The information processing device according to Supplementary note 7, wherein the disposing means disposes, in the virtual space, more non-player characters in an area in which a density of the players is smaller than in an area in which the density of the players is larger.

The above configuration makes it possible to dispose more NPCs in an area in which the density of the players is smaller, and to make the area lively.

(Supplementary Note 9)

The information processing device according to any one of Supplementary notes 5 to 8, wherein: the character generating means generates the character information of the non-player character with use of a licensed character material or a character material that does not require licensing.

The above configuration makes it possible to prevent a problem such as infringement of a right from occurring due to the NPC generated on the basis of the character information having been generated.

(Supplementary Note 10)

The information processing device according to any one of Supplementary notes 1 to 9, wherein the acquisition means acquires a licensed action history or an action history that does not require licensing.

The above configuration makes it possible to prevent a situation in which the action to be performed by the NPC is viewed as a problem because the action is similar to an action of a particular player that has existed in the past.

(Supplementary Note 11)

An information processing method, wherein at least one processor acquires an action history of one or more players in a virtual space and generates, from the action history of the one or more players, action information that indicates an action which a non-player character is to perform.

The above configuration makes it possible to provide an effect equivalent to the effect that is yielded by the information processing device according to Supplementary note 1.

(Supplementary Note 12)

A program for causing a computer to execute: an acquisition process of acquiring an action history of one or more players in a virtual space; and a generation process of generating, from the action history of the one or more players, action information that indicates an action which a non-player character is to perform.

(Supplementary Note 13)

An information processing device including at least one processor, wherein the processor executes an acquisition process and a generation process.

Note that this information processing device can further include a memory, and in this memory, a program for causing the processor to execute the acquisition process and the generation process can be stored. Further, the program can be stored in a non-transitory tangible storage medium that can be read by a computer.

### REFERENCE SIGNS LIST

1, 2, 3, 3A information processing device
11, 21, 31 acquisition section
12, 22, 32 action information generating section
20, 30, 30B control section
23, 33 character generating section
24, 34 disposing section
40 storage section
50 communication section
60 operation receiving section
70 display section

1. An information processing device comprising at least one processor,
the processor executing:
an acquisition process of acquiring an action history of one or more players in a virtual space; and
an action information generating process of generating, from the action history of the one or more players, action information indicating an action which a non-player character is to perform.

2. The information processing device according to claim 1, wherein:
the action history of the one or more players is classified into a plurality of categories and managed; and
the action information generating process is a process in which the action information is generated from the action history of a category that has been selected from the plurality of categories.

3. The information processing device according to claim 2, wherein
the action information generating process is a process in which the category is selected in accordance with the action and a position of the one or more players in the virtual space or in accordance with the action or a position of the one or more players in the virtual space.

4. The information processing device according to claim 1, wherein
the action information generating process is a process in which the action information is generated with use of a generative model.

5. The information processing device according to claim 1, wherein
the processor further executes a character generating process of generating character information of the non-player character that is to perform the action indicated by the action information.

6. The information processing device according to claim 5, wherein
the processor further executes a disposing process of disposing, in the virtual space, the non-player character based on the character information that has been generated in the character generating process.

7. The information processing device according to claim 6, wherein
the disposing process is a process in which a position at which the non-player character is to be disposed is determined in accordance with a position of the one or more players in the virtual space.

8. The information processing device according to claim 7, wherein
the disposing process is a process in which more non-player characters are disposed, in the virtual space, in an area in which a density of the players is smaller than in an area in which the density of the players is larger.

9. The information processing device according to claim 5, wherein:
the character generating process is a process in which the character information of the non-player character is generated with use of a licensed character material or a character material that does not require licensing.

10. The information processing device according to claim 1, wherein
the acquisition process is a process in which a licensed action history or an action history that does not require licensing is acquired.

11. An information processing method, wherein
at least one processor acquires an action history of one or more players in a virtual space, and generates, from the action history of the one or more players, action information that indicates an action which a non-player character is to perform.

12. A computer-readable non-transitory tangible storage medium storing therein a program for causing a computer to execute:
an acquisition process of acquiring an action history of one or more players in a virtual space; and
a generation process of generating, from the action history of the one or more players, action information that indicates an action which a non-player character is to perform.
